(19) United States
(12) Patent Application Publication
(10) Pub. No.: US 2016/0214422 A1
(43) Pub. Date: Jul. 28, 2016

(54) POLYOLEFIN BASED IDENTIFICATION DOCUMENTS

(71) Applicant: SMARTRAC IP B.V., Amsterdam (NL)

(72) Inventors: Mitchell Peter DeYoung, Oceanside, CA (US); Alex Cowie, Minneapolis, MN (US)

(21) Appl. No.: 15/003,810

(22) Filed: Jan. 22, 2016

Related U.S. Application Data
(60) Provisional application No. 62/107,495, filed on Jan. 25, 2015.

(51) Int. Cl. B42D 25/24; B42D 25/23; B42D 25/47

(52) U.S. Cl. CPC B42D 25/24; B42D 25/47; B42D 25/23

(57) ABSTRACT

This disclosure relates generally to paper and textile based materials with associated protective coatings or coverings. Many products, such as identification documents, experience wear and tear as they are subsequently used, scratched, exposed to elements or tampered with. This invention provides methods, apparatuses, and systems to protect an element or product, such as an identification document, from wearing, weathering, tampering and other detrimental outside effects through the use of a surrounding coating or covering such a polyolefin based coating, of which in some embodiments, includes ingenious features such as a monobloc structure, multiple layers, a porous matrix, among others.

### FIELD OF TECHNOLOGY

This disclosure relates generally to paper-based and textile-based materials with associated protective coatings or coverings. In one example embodiment, the disclosure relates to methods, apparatus, and systems to protect a material from weathering, tampering and other outside effects through the use of a surrounding coating or covering such as polyolefin based coating.

### BACKGROUND

Within many fields, notably in paper-based and textile-based materials and more specifically sensitive document materials such as for passports, security and a need for protection is paramount. Documents, such as passports, can incorporate several features designed to ensure that counterfeiters cannot alter the integrity of the documents. Although very secure, modern passports can be flawed due to inherent weaknesses of paper-based or textile-based materials, which includes a potential removal of the cover or associated pages by slicing or splitting the cover off the pages or documents. For example, counterfeiters can take advantage of the weakness in the cover material as it is disproportionally weaker than the inlay layer thus making the adhesive layer between the two layers the point of failure. Also, the nature and thickness of the cover material allows for a partial removal of an element either by slicing or splitting. This allows counterfeiters to remove the sewing in the hinge and add or remove the inner visa pages, which provides an avenue for further counterfeiting.

FIG. 1 illustrates a prior art document according to some embodiments. A document 100 can have document information printed on a paper (or textile) layer 130 covered by a varnish layer 150. A polyolefin layer 110 and a paper (or textile) layer 130 can be glued together. e.g., using an adhesive layer 120, with an adhesive adopted to polyolefin and to paper (or textile). The adhesion between the polyolefin layer 110 and the paper layer 130 may be insufficient and or decrease over time due to the binding of different materials. Thus the layers can be delaminated mechanically 140 along the bonding layer 120, for example, using a knife or a sharp object. In addition, the paper (or textile) layer 130 can be sliced 145 and split 135, due to heterogeneous characteristics of the paper or textile material. Moreover delamination can be achieved through application of increased temperatures.

These described methods are just some of the many methods, with increasing creativity, that counterfeiters enlist that take advantage of the inherent flaws of the current industry standard and common passport design as described in the above embodiment. As such, it becomes clear that within prior designs and known industry practices, including the embodiment described above, a counterfeiter is able to alter documents such as passports in their current design.

Thus, there is a need for a protective apparatus in secure documents such as government issued identification documents that is both more resistant and durable to outside characteristics and wear, such as tampering and counterfeiting, than the industry standard as described in the above embodiment which is vulnerable to tampering and counterfeiting.

### SUMMARY

Disclosed are methods, apparatus and systems that provide a coating or surrounding matrix of a material, disclosed as a cover material, over a textile-based, paper-based or other material, disclosed as the inlay material or inlay element. Paper-based or textile-based materials are widely used in documents, most notably identification documents such as government issued passports and identification documents. Paper-based materials, such as a polymer-fiber reinforced paper are most widely used as they are easy to process. Polymer-fiber reinforced textile is sometimes used, but less frequently due to the difficulty in processing and higher cost. These documents may also have other inlay elements, such as photos or devices such as biometric identification devices, NEC devices, RFID devices and other electronics and structures which may aid in the use of the identification document.

The included method, system or invention provides a basis for covering or protecting any type of material or element such as textiles, papers or composites. These covered materials are designated as the inlay material or inlay element, and may be of any type. In a preferred embodiment the inlay material or inlay element may be a document. such as a passport, driver's license, identification card, other printed material such as a story or photo or devices such as a display, RFID or NFC devices. etc. The inlay material or element may be of any paper based, textile based, synthetic, metallic or composite material including wood pulp paper, cotton based paper, textiles including composite textiles, organics or inorganics and may also constitute of formed devices such as electronic devices, semiconductors, antennas and associated micro-electronics such as an RFID tag or NFC devices. In essence, the inlay material or inlay element is an item or items or element or elements to be protected or covered by the covering material.

The covering material may be of any material such as a composite material or matrix, as well as constitute different layers of differing materials, or in a preferred embodiment, may constitute a monobloc structure of a homogenous material. In a preferred embodiment the material may be polyolefin based and may be designated as a film. The cover material which may be polyolefin, or similar types, may be a microporous matrix composed essentially of an interconnecting porous network of ultrahigh molecular weight, high density polyethylene

One particular type of polyolefin material that may be used is a polyolefin film as described in U.S. Pat. No. 4,861,644 which is herein incorporated by reference. The structure may be constructed to form a microporous matrix having a network of interconnecting pores communicating throughout the matrix. The average diameter of the pores within the matrix may be any measurement such as between 0.02 and 50 micrometers. The matrix may be formed of any percentage of polyolefin or other materials with an intended characteristic in both volume and mass, and may also include any other materials to provide a different characteristic from the matrix material, such as an additive for coloring, an additive or material for strengthening, an additive for rigidity or an additive for UV protection. As such, the additives may be of any type of material and the microporous matrix may be filled with any filler such as siliceous filler, mica, montmorillonite, kaolinite, asbestos, talc, diatomaceous earth, vermiculite, calcium silicates, aluminum silicates, sodium aluminum silicate, alumina silica gels and glass particles and any other material for any intended purpose.

The covering material may be of homogenous materials and construction such as in the preferred embodiment of a polyolefin matrix impregnated by silica or another material with a homogenous construction and distribution. The covering material may also be of heterogeneous construction, material and structure, such as using different materials within the construction to make a heterogeneous covering material or matrix, or using the same material throughout the matrix but in the process of applying the material, heat or sonic other process is provided to enact different characteristics to different areas of the material, thus making a heterogeneous matrix structure using the homogenous material. The preferred embodiment uses a homogenous covering material providing a homogeneous matrix with impregnation by an additive.

The methods above, with using a material such as a polymer material which may be polyolefin, as a protective cover or surrounding layer over inlay materials or elements, can prevent the inlay material or elements, such as a secure document, from being sliced and extracted or tampered with in the same manner as paper or other structure as seen in the Prior Art, thus protecting the secure document pages from counterfeiting. The methods may include using a covering material having a high content of dispersed hard particles, such as silica within the covering material, which can prevent the cover from being melted or sliced without destroying the document itself In some embodiments, the present invention discloses documents that include a siliceous fillers containing microporous polyolefin material as a passport cover material, e.g., replacing paper-based or textile-based materials. The passport documents can include several layers of siliceous fillers containing microporous polyolefin materials, with embedded document elements, such as radio frequency identification (RFID) transponders and printed information.

The films as taught by the present invention, provide a means to form secure documents, or provide an ability to form a coating on a document or other inlay material or element for any other reason. The documents or product generated from the method may include laminating several layers, such as two or more layers of the above mentioned microporous polyolefin matrix materials which may be filled or impregnated. The lamination of multiple layers can form a structure that, due to the nature of the polyolefin or similar material, is bonded together to form a kind of a monobloc structure, a structure that cannot be sliced or split between the layers without destroying the composite structure. The structure as an improvement on the Prior Art, provides a basis where the covering material fully encompasses the inlay material and as such, with the fully encompassing monobloc structure, provides a characteristic that is hard to tamper or cut as seen in the Prior Art, as a knife or other sharp edge does not have a weakened area between the inlay material and covering material in which to penetrate unlike within the Prior Art.

In addition, the composite structure can show enhanced durability with a wide range of design opportunities like direct print or coloring for the secure documents or other types of materials needed to be coated or surrounded, such as a document with a RFID, or structures used in manufacturing or otherwise, such as plastics or sheets used within computer devices and supplies. These materials may be a coverstock of a document, such as the cover of passport, or may also be within the inner stock such as a visa page or visa pages of a passport. The material may also be synthetic or any material other than textile-based or paper-based.

In some embodiments, an adhesive material may be enlisted between the layers of the inlay material or inlay elements and covering material, or between layers of the covering material. The adhesive materials may be selected or optimized to allow for a strong adhesion between various or any components or materials. For example, the adhesive can be elected or optimized for a strong adhesion between two layers of the covering material such as the polyolefin based materials or between the filler portions or a combination thereof. Moreover the adhesive may be optimized to allow for maximum adhesion to the inlay material or elements such as parts of the RFID transponder such as the antenna wire, the RFID chip, the etched or printed elements of the RFID transponder, and a strong adhesion among the other parts of the RFID transponder or other inlay elements.

In some embodiments, an adhesive material may be enlisted between the layers of the inlaid elements and covering material, or between the pluralities of layers of the covering material. The adhesive materials may be selected or optimized to allow for a strong adhesion between various or any components or materials such as an adhesive that bonds to paper or plastic of which the inlaid elements may be made of and the polyolefin material, or an adhesive that bonds the polyolefin material layers together. Examples of adhesives may be synthetic elastomer-based adhesives, hot melt adhesives, pressure sensitive acrylic co-polymer emulsions, visible light curing adhesives, cyanoacrylates, or reactive (meth) acrylate glues, as well as reactive urethanes. The adhesives may be applied with or without surface treatment. Also in place of adhesives other process or products may be used such as heat, friction, thermal welding, captive designs such as interlocking pieces, etc.

An additional layer which may be described as varnish and may be of any material, can be added on the internal layer, on the external layer or on any layer of present invention. The varnish can be made of any material such as the industry standard of a combination of a drying oil, a resin and a thinner or solvent. The varnish may be glossy, satin or semi-glossy and of differing levels of transparency. The varnish also may have qualities such as qualities that provide certain outward appearances, such as a tint or that provide tamper evidence such as heat susceptibility using elements such as color changing dyes. These characteristics may be found within the covering material or inlay material or inlay elements as well. The varnish, in a preferred embodiment is provided on the external layer and can provide protection from wear and other characteristics. Having the varnish on the outside layer, provides a basis for both protection from wear due to the characteristics of the material the varnish is made up of but also because the varnish is on the outermost layer, the area between the monobloc or non-monobloc covering material, and inlay element or materials is not structurally differentiated and as such the monobloc covering as aforementioned is held intact. Thus, trying to tamper or penetrate the adhesion, would only result in removing the varnish and would not be successful in reaching the inlay material or elements, as the varnish and associated connection of the varnish layer and covering layer is solely on the external side of the covering material.

Polyolefin and many other materials used within the covering and identification materials are also highly receptive to reactive adhesives, which offers a tamper-resistant and destruction preventing bond between the layers. The bond between these two components may be excellent even without a glue or adhesive layer between the intended film and the paper. However, an adhesive layer of any thickness may be included to increase the bond strength between the material such as paper and the coating and may provide a basis for providing, since the two components are made of the same material, a final structure that is formed to be a monobloc structure e.g., preventing thermal, stress or strain mismatches, thus reducing warpage issues, for example. The life characteristics can be improved, for example, having better water resistance and wear and tear resistance. These materials, and the adhesive may be configured to complement the paper, or structures, such as the RFID transponder, to aid in both adhesion and other characteristics such as allowing the passing of radio waves.

Additionally, the present invention may also comprise to have multiple layers of the covering material, in that it may provide intended characteristics, such as multiple layers may provide better wear characteristics or each layer may provide a different materials within the microporous matrix, such as one layer providing UV protection, the next providing scratch resistance, and another layer or the presence of many layers providing further deterrent to the ability to tamper with or counterfeit the inner document or inlay material.

The methods and systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and are not limited to the figures of the accompanying drawings, in which, like references indicate similar elements.

FIG. 1 is a cross sectional view of a Prior Art showing a document with alternate layers of polyolefin, textile or paper as the industry standard and exampling methods of counterfeiting.

FIG. 2A is a cross sectional view of a document showing the embodiment of the present invention with two polyolefin based film and bonded by an adhesive laver.

FIG. 2B is a cross sectional view of a document showing an embodiment with an inner layer and outer layer of polyolefin without any adhesive layer and with a monobloc structure.

FIG. 2C is a cross sectional view of a document showing an embodiment with multiple layers of polyolefin without any adhesive layer and a monobloc structure.

FIG. 3A-3D illustrate a process for forming a document according to some embodiments.

FIG. 3A is a cross sectional view of an embodiment. of a provided first polyolefin based film.

FIG. 3B is a cross sectional view of an embodiment of an identification element formed on a provided first polyolefin based film.

FIG. 3C is a cross sectional view of an embodiment of an identification element formed on a provided first polyolefin based film with an adhesive layer.

FIG. 3D is a cross sectional view of an embodiment of an identification element formed on a provided first polyolefin based film with an adhesive layer and second polyolefin layer and adhesive layer.

FIG. 4A-4C illustrate a process for forming a document according to some embodiments.

FIG. 4A is a cross sectional view of an embodiment of a provided. first polyolefin based film.

FIG. 4B is a cross sectional view of an embodiment of an identification element formed on a provided first polyolefin based film.

FIG. 4C is a cross sectional view of an embodiment of an identification element formed on a provided first polyolefin based film with an adhesive layer and with a monobloc structure.

FIG. 5A is a systematic diagram of an embodiment in which an identification element is placed between two films and optional adhesive.

FIG. 5B is a systematic diagram of an embodiment in which an identification element is incorporated in a film and a coating adhesive with laminating a second film.

FIG. 6A is an example embodiment of a passport or document in which the present invention is enlisted.

FIG. 6B is an example embodiment of a passport, document or booklet with corresponding cover and inlay pages in which the present invention is enlisted.

FIG. 6C is an example embodiment of a passport or document or booklet inner page in which the present invention is enlisted.

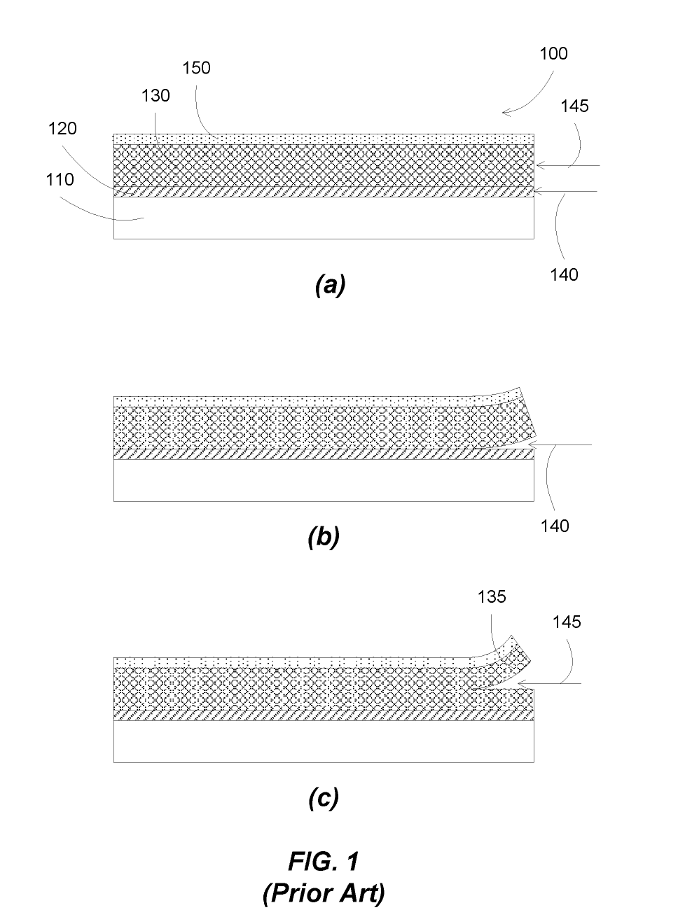

Other features of the present embodiments will be apparent from the accompanying drawings and from the detailed description that follows.

### DETAILED DESCRIPTION

Disclosed are methods, apparatus, and systems that may provide a covering or suspension for an inlay material or inlay elements such as a textile or paper based material, document or object that may protect from tampering, counterfeit, wear and other environments. The present invention may be based on the coating being of a polyolefin based material, other microporous materials or other materials, and may be of different structures, including multiple layers, heterogeneous or homogeneous and the inclusion of an adhesive to provide specific characteristics, such as a material that hardens the matrix or provides wear or tamper resistance. These preferred embodiments below are in addition to the features and characteristics described in the above summary and aforementioned figures and description. Although the present embodiments have been described with reference to specific example embodiments, it will be evident that various modifications and changes may be made to these embodiments without departing from the broader spirit and scope of the various embodiments. It should be understood by one of ordinary skill in the art that the terms describing processes, products, element, or methods are industry terms and may refer to similar alternatives. In addition, the components shown in the figures, their connections, couples, and relationships, and their functions, are meant to be exemplary only, and are not meant to limit the embodiments described herein.

Example embodiments are illustrated by way of example and are not limited to the figures of the accompanying drawings, in which, like references indicate similar elements.

In one or more embodiments, in addition to the above or below embodiments, the present invention relates to a coating.

In one or more embodiments, in addition to the above or below embodiments, the present invention relates to a coating such as a polyolefin coating.

In one or more embodiments, in addition to the above o below embodiments, the present invention relates to a coating such as a polyolefin coating that encompasses an inlay material or object either entirely or on any number of sides.

In one or more embodiments, in addition to the above or below embodiments, the present invention relates to a coating such as a polyolefin coating that encompasses an inlay material or object such as a passport document, passport page, or other identification material either entirely or on any number or sides.

In one or more embodiments in addition to the above or below embodiments, the present invention may teach an inlay material that may be of any type, structure, form or composition such as a device, document, printed material, display etc.

In one or more embodiments in addition to the above or below embodiments the present invention relates to a coating such as a polyolefin coating that encompasses an inlay material or object such as an RFID or other devices such as NFC or biometric identification devices either entirely or on any number of sides.

In one or more embodiments in addition to the above or below embodiments, the coating material may be of any material such as polyolefin or such as any synthetic, metallic, organic, inorganic or other materials.

In one or more embodiments, in addition to the above or below embodiments, the present invention may teach that the coating may be of any material such as polyolefin or another synthetic, metallic or organic material, of which provides a microporous matrix with any diameter or volume of pores.

In one or more embodiments, the present invention may, in addition to the above or below embodiments, have the coating be made of polyolefin or another synthetic, metallic organic, inorganic or other material, of which provides a porous matrix, which may be a micro porous matrix, of which a filling material is impregnated.

In one or more embodiments, the present invention may, in addition to the above or below embodiments, have the coating be made of polyolefin or another material, of which provides a porous matrix, of which a filling material is impregnated, and of which may be a material such as silica, or any material with a desired characteristic, such as to make the present invention more resistant to tampering by changing the characteristic to be harder, more rigid, etc.

In one or more embodiments, in addition to the above or below embodiments, the present invention may teach the surrounding material to be of any thickness or any plurality of layers.

In one or more embodiments, in addition to the above or below embodiments, the present invention may teach the surrounding material to be of any thickness or any plurality of layers to provide for a differing level of hardiness, toughness, tamper resistance or any other aspect. For example, for one type of embodiment, there is only one layer such as a monobloc layer that is comparatively thin, such as 0.1 mm wherein the need of the layer is to protect against water or dust. In another example, the monobloc layer may be 3 mm wherein the monobloc protects the embedded element, such as a document, against dust and water but also intrusion from solid objects such as a knife or from scratches. Additionally, in other embodiments, the single layer may be replaced by a plurality of layers, of which may be formed around, or be attached or formed with an adhesive layer such as with a glue, or other bonds such as being formed together with heat or friction, etc.

In one or more embodiments, in addition to the above or below embodiments, the present invention may teach the embedded depth of the embedded element in the surrounding material may be of any depth or thickness and may be presented to provide various protections based on the depth or thickness of the layer or layers of material.

In one or more embodiments, in addition to the above or below embodiments, the present invention may teach to the surrounding material of which may be of different types within different layers, such as having a layer with the polyolefin matrix having a UV reflective material embedded and another layer having silica embedded, providing hardness, rigidity or another characteristic to the structure.

In one or more embodiments, the present invention may, in addition to the above or below embodiments, enlist the use of an adhesive to bond the different layers of the present invention such as to provide a better bond between the surrounding layer and the inlay layer to reduce tampering. The adhesive may be of any type, and may be chosen due to the characteristics of the materials, such as polyolefin having a desirable characteristic to bond with a certain adhesive, or the adhesive having a characteristic to bond with the inlay material.

In one or more embodiments, the present invention may, in addition to the above or below embodiments, provide a structure in which the surrounding material is formed as such to provide a monobloc structure

In one or more embodiments, the present invention may in addition to the above or below embodiments, provide a structure in which the surrounding material is formed as such to fully encompass the material.

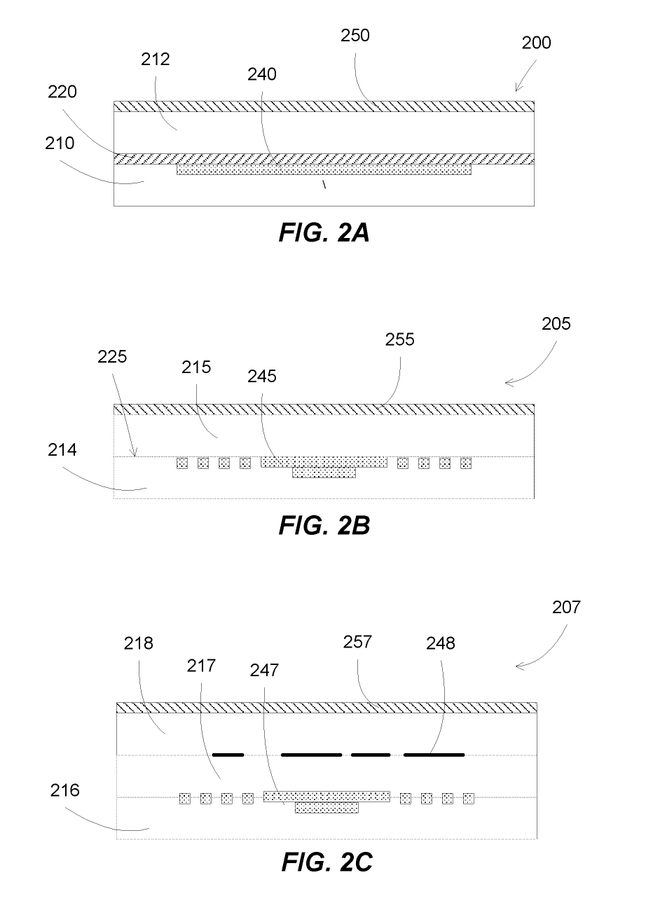

In one or more embodiments, the present invention may, in addition to the above or below embodiments, provide a structure in which the surrounding material is formed as such to encompass the material on any number of sides and may form a monobloc structure. The structure as an improvement on the Prior Art, provides a basis where the covering material fully encompasses the inlay material and as such with the encompassing and monobloc structure, provides a characteristic that is hard to tamper or cut as seen in the Prior Art, as a knife or other sharp edge does not have a weakened area between the inlay material and covering material in which to penetrate unlike in the Prior Art and exampled in FIG. 2B areas 213 and 215 becoming a monobloc structure encompassing the inlay material or element 245 completely.

In one or more embodiments, the present invention may, in addition to the above or below embodiments provide a structure where a varnish is applied to any of the layers or structures of the covering material, inlay materials or inlay elements. The varnish may be of any type or material as described within the summary and may provide a basis for any and all characteristics such as wear resistance or other physical characteristics such as a desired tint or coloring. Also, the varnish may provide a basis for tamper evident markers such as temperature indicating dyes or other characteristics. As well as this, the varnish, in a preferred embodiment, may be on the external layer of the present invention. This provides a basis that the covering material and inlay materials and inlay elements and their associated protections afforded by the monobloc or other structures as described are still effected as the varnish, on an external layer, does not provide an intrusion into the spaces between the inlay and covering layers and as such the inner structures are held intact and resistant to penetration or other tampering. By a basis of tampering of the varnish, the removal of the varnish does not allow access to the inlay materials, and may actually provide a basis for tamper evidence.

In one or more embodiments, in addition to the above or below embodiments, the present invention may provide that the surrounding material is made to provide a stratified or layered and monobloc or non-monobloc structure.

FIGS. 2A-2C illustrate a preferred embodiment of documents using a. covering material which may be polyolefin based according to some embodiments. In FIG. 2A, a document 200, such as a passport book, can include a covering material such as two polyolefin based films 210 and 212, and may be bonded by an adhesive layer 220. An identification element 240 can be placed between the two covering materials such as films of a polyolefin based material 210 and 212, shown as embedding inside the covering material 210, but other configurations can also be used, such as embedding inside the covering material such as a polyolefin based material 212 or having a portion embedded in the covering material 210 and a portion embedded in the covering material such as a polyolefin based material 212. For example, the covering material such as a polyolefin based film 210 can be an inner layer of a passport document, and the covering material such as a polyolefin based film 212 can be an outer cover layer of the passport document or other item. A same adhesive. material can be used to cover the covering material such as polyolefin materials 210/212 and the identification element 240. Alternatively, the adhesive may only cover the covering material such as polyolefin materials 210/212, or different adhesive materials may be used for the polyolefin materials and for the identification element. An optional layer of varnish 250 can be used coat the covering material such as the polyolefin based film layer 212 for protecting the outer cover layer.

The identification element 240 can be protected in all sides by the covering material such as polyolefin based films 210 and 212. For example, the identification element 240 can be smaller, e.g., having a smaller lateral surface than that of either the covering material such as polyolefin based films 210 or 212. In some embodiments, the covering material such as a polyolefin based film 210 and 212 can include a silica filled microporous polyolefin material

The identification element 240 can include an inlay element such as a RFID transponder, embedded in the bottom covering material which may be a polyolefin based film 210, e.g., the bottom covering material such as a polyolefin based film 210 can function as a recipient for the RFID transponder or other inlay element. Alternatively, the identification element 240 can include other identification forms, such as printed identification, for example, on an inner surface of the covering material such as polyolefin based film 210 or 212.

FIG. 2B shows a document 205 formed by an inner layer of covering material such as a polyolefin based material 214 and an outer cover layer, also of a covering material such as a polyolefin based material 215, without using an adhesive at position 225 between covering materials. The inner layer 214 can include an inlay of an identification element such as a RED transponder 245. The cover layer 215 can be protected by a coating of varnish 255.

FIG. 2C shows a document 207 formed by multiple layers of covering material such as a polyolefin based material 216, 217 and 218. The document 207 is shown without any adhesive layer. Alternatively, an adhesive layer can be provided between any two layers of the covering materials such as polyolefin based materials, for example, to increase the bonding strength. Identification elements can be embedded within the polyolefin based films, e.g., completely covered by the covering materials such as polyolefin based films. For example, an identification element such as a RED transponder 247 can be inlayed in the covering material 216 without any exposure to the outside ambient or environment. An inlay element such as a printed document 248 can also be embedded between the covering material 217 and 218 without any exposure to the outside ambient or environment. The cover layer 218 can be protected by a coating of varnish 257.

In some embodiments, the present invention discloses methods, and documents generated from the methods, to coat a covering material such as a polyolefin based film with a protective layer. For example, a varnish layer can be coated on a polyolefin based film to provide protection to a document using polyolefin as Monobloc material Technology and material composition have been developed to form a varnish coating on polyolefin layer with good adhesion.

In some embodiments, the present invention discloses methods, and documents generated from the methods, to build identification documents or other documents or inlay elements with layers of a covering material such as is polyolefin based material and with or without adhesive in between. The adhesive introduced between two covering layers such as polyolefin layers facilitates very strong interlayer bonds thus preventing the covering layer delamination mechanically. The adhesive layer can be of any thickness and can be very thin, e.g., sub millimeter thickness such as less than 0.5 mm or less than 0.1 mm in order to strictly avoid susceptibility to any kind of tamper actions, be it a knife or organic solvent. Alternatively, layers of the covering material such as polyolefin can be well bonded without the adhesive layer.

In some embodiments, the present invention discloses secure documents or identification elements, and method to form secure documents or other identification elements, including the construction with two layers of a covering material such as a polyolefin based material, with integrated inlay element such as RFID functionality by using one covering layers such as layer coated with varnish. The construction of documents or elements using multiple layers of a covering material can prevent any tampering such as a delamination attack and can create an additional security feature. The multiple layers of a covering material can be bonded together with or without an adhesive layer.

For example, when two layers of a covering material are sealed, e.g., bonded together, the adhesive material can flow into the covering material substrate's matrix to create a strong mechanical bond. The mechanical bond can be adequate to cause the composite structure of two bonded layers to be immediately and permanently distort with any attempt to alter it, e.g., slicing or splitting the composite structure.

The layers of covering material such as a polyolefin based material can include a microporous matrix that produces a cushioning effect that can protect the inlay elements such as RFID chips and other embedded electronics from cracking, chipping and displacement, resulting in more secure data and longer service life. The micropores can absorb polymers and other materials, allowing the use of polymers between two layers of the covering material. For example, materials to be used for bonding layers of the covering material can include polyvinyl chloride (PVC), polyethylene terephthalate (PET), polypropylene (PP), polycarbonate (PC), high-density polyethylene (HDPE), acrylonitrile butadiene styrene (ABS), sheet molding compound (SMC), polyurethane foam, foam rubber, synthetic rubber, fiberglass, and thermoplastic polyolefin (TPO)/

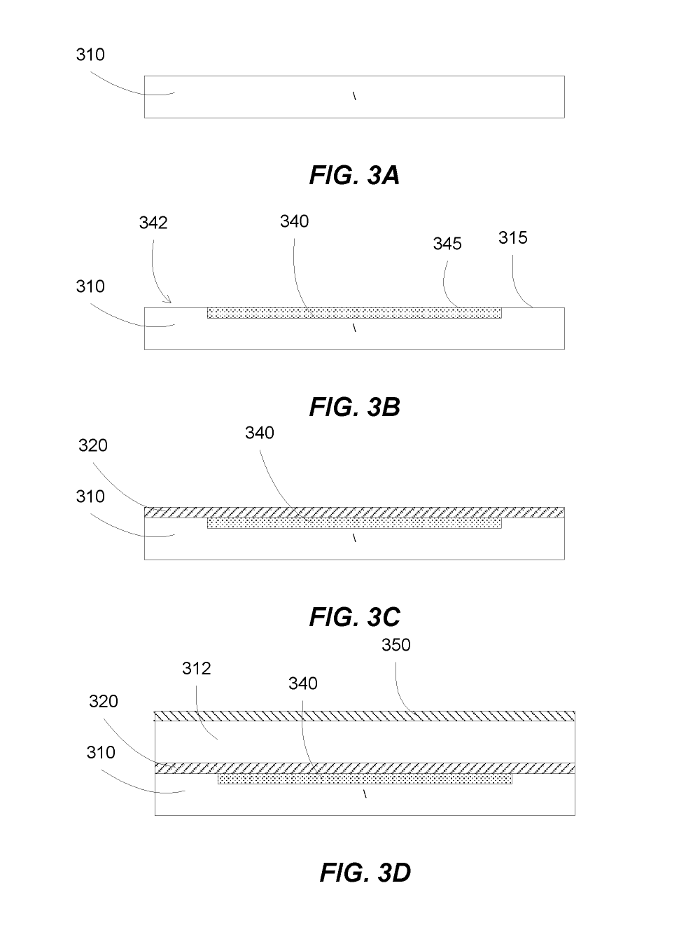

FIGS. 3A-3D illustrate a process for forming an inlay clement such as a document according to some embodiments. In FIG. 3A, a first covering material such as a polyolefin based film 310 can be provided. The covering material such as a polyolefin based film 310 can include any filled microporous material such as a silica filled microporous polyolefin material. In FIG. 3B, an identification element 340 can be formed on the first covering layer such as a polyolefin based film 310. The identification element 340 can be formed inside the film 310, e.g., completely inside the film 310 so that there is no portion of the identification element 340 exposed to the outside ambient or environment. For example, there is a portion 342 of the covering material such as a polyolefin based film 310 around the identification element 340. Thus the security strength of the document is determined by the film 310 and not affected by the identification element 340.

The identification element 340 can include an RFID element or other element, which can be embedded inside a surface of the film 310, e.g., forming an inlay film. The identification element 340 can include a printed element, such as a printed layer (e.g., paper or textile). Since the identification element is completely covered by the covering material such as a polyolefin based film 310, the strength of the document can be unaffected by the weakness of the inlay element such as the paper or textile material, e.g., there can be no exposed paper material to allow slicing or splitting. The printed element can also be printed directly on the first covering material which may be a polyolefin based film 310.

As shown, the identification element 340 is embedded in the first covering material which may be a polyolefin based film 310, e.g., the identification element 340 is integrated in the film 310 in its entirety so that the top surface 345 of the identification element 340 is leveled with the top surface 315 of the first covering material 310. Other configurations can be used, such as a part of the identification element 340 can be above the top surface 315 of the film 310. For example, the identification element 340 can include a transponder having an RFID chip coupled to antenna wires, and a part of the wires and/or a region of the chip can be above the level of the film 310, e.g., above the top surface 315. The position of the identification element 340 with respect to the polyolefin based film 310 can allow for combinations of features with respect to the choice of adhesives 320.

In FIG. 3C, a layer of adhesive 320, e.g., a layer of material that can function to bond two layers of the covering material such as a polyolefin based material, can be coated on the film 310. The adhesive can coat the identification element 340 and the covering material such as a polyolefin based film 310 or can coat only the covering material 310, e.g., the portion of the covering material 310 that is not covered by the identification element 340. Alternatively, different adhesive materials can be used, e.g., one for the covering material 310 and one for the identification element 340.

In FIG. 3D, a second covering material which may be a polyolefin based film 312 can be placed or laminated on the adhesive layer 320, bonding the first covering material 310 to the second covering material 312, and encapsulate the identification element 340. An optional layer of varnish 350 can be provided on the second covering material 312.

As shown in FIG. 3D, the adhesive layer 320 is coated on the covering material which may be a polyolefin based film 310. Alternatively, the adhesive layer can be coated on the top covering material which may be a polyolefin based film 312.

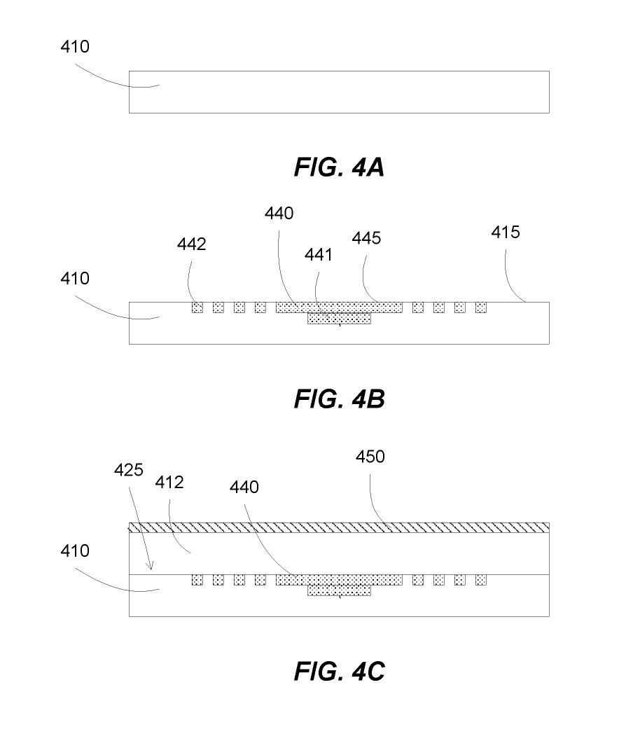

FIGS. 4A-4C illustrate a process for forming a protective covering over an element such as a document according to some embodiments. In FIG. 4A, a first covering material such as a polyolefin based film 410 can be provided. The covering material 410 can include an impregnated material such as a silica filled microporous polyolefin material. In FIG. 4B, an identification element 440, such as an RFID element, can be embedded in the first covering material 410, forming an inlay layer.

As shown, the identification element 440 is embedded in the first covering material which may be a polyolefin based film 410, e.g., the identification element 440 is integrated in the film 410 in its entirety so that the topmost surface 445 of the identification element 440 is leveled with the top surface 415 of the first covering material 410. Other configurations can be used, such as a part of the identification element 440 can be above the top surface 415 of the film 410. For example, the identification element 440 can include a transponder having an RFID chip 441 coupled to antenna wires 442, and a part of the wires and/or a region of the chip can be above the level of the film 410, e.g., above the top surface 415.

In FIG. 4C, a second covering material which may be a polyolefin based film 412 can be placed on the first covering material 410, bonding the first covering material 410 to the second covering material 412, and encapsulate the identification element 440. The two first covering material 410 and 412 can be bonded at exposed areas 425, e.g., bonding without any adhesive layer. An optional layer of varnish 450 can be provided on the covering material 412.

Other configuration can be used, such as the addition of printed information, e.g., printing on either one of the two covering materials which may be polyolefin based films 410 and 412, or adding a printed layer between the two covering materials which may be two polyolefin based films 410 and 412. In addition, another layer of a covering material which may be a polyolefin based film can be added.

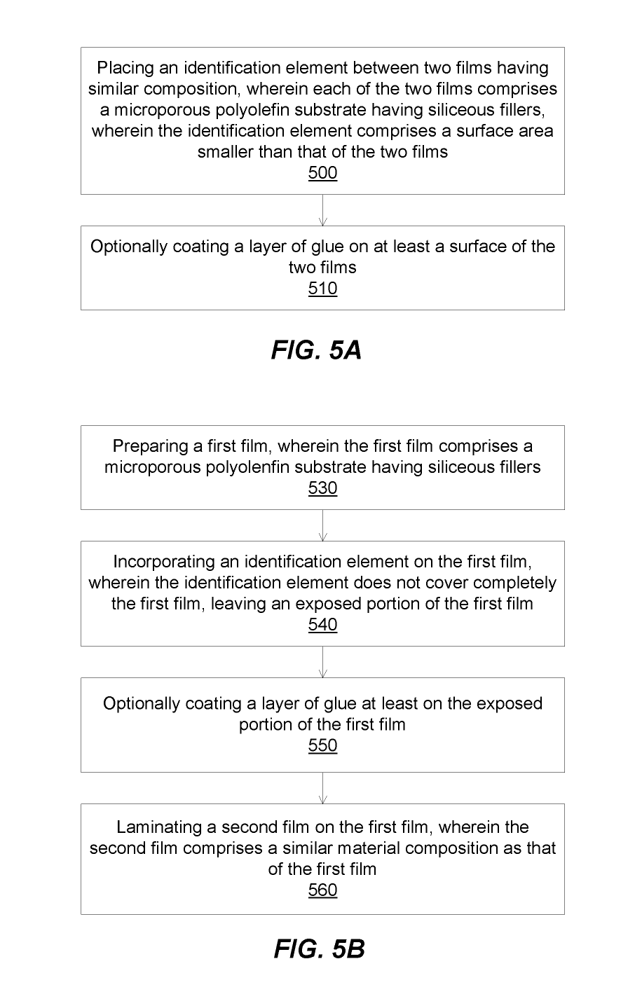

FIGS. 5A-5B illustrate flow charts for forming an inlay element such as a document according to some embodiments. An identification element can be completely covered between two layers of the covering material which may be siliceous particulate filled microporous polyolefin matrix materials. The covering material which may be polyolefin layers can be bonded together to form a strong seal, protecting the identification element against tampering. A varnish layer can be coated on an outer surface of the composite structure of the covering material such as polyolefin layers and identification element for protection.

In FIG. 5A, operation 500 places an identification element between two films having similar composition. Each of the two films can include a microporous polyolefin substrate having siliceous fillers. The identification element can have a surface area smaller than that of the two films, so that the identification element can be completely surrounded at all sides by the two films. A protection coating can be placed on a covered film of the two films. The protection coating can include a varnish layer. Operation 510 optionally coats a layer of adhesive on at least one of the opposing surfaces of the two films to allow for increased bonding strength between the layers.

In FIG. 5B, operation 530 prepares a first film, wherein the first film comprises a microporous polyolefin substrate having siliceous fillers. Operation 540 incorporates an identification element on the first film, wherein the identification element does not cover completely the first film, leaving an exposed portion of the first film. Operation 540 optionally coats a layer of adhesive at least on the exposed portion of the first film. Operation 540 laminates a second film on the first film, wherein the second film comprises a similar material composition as that of the first film.

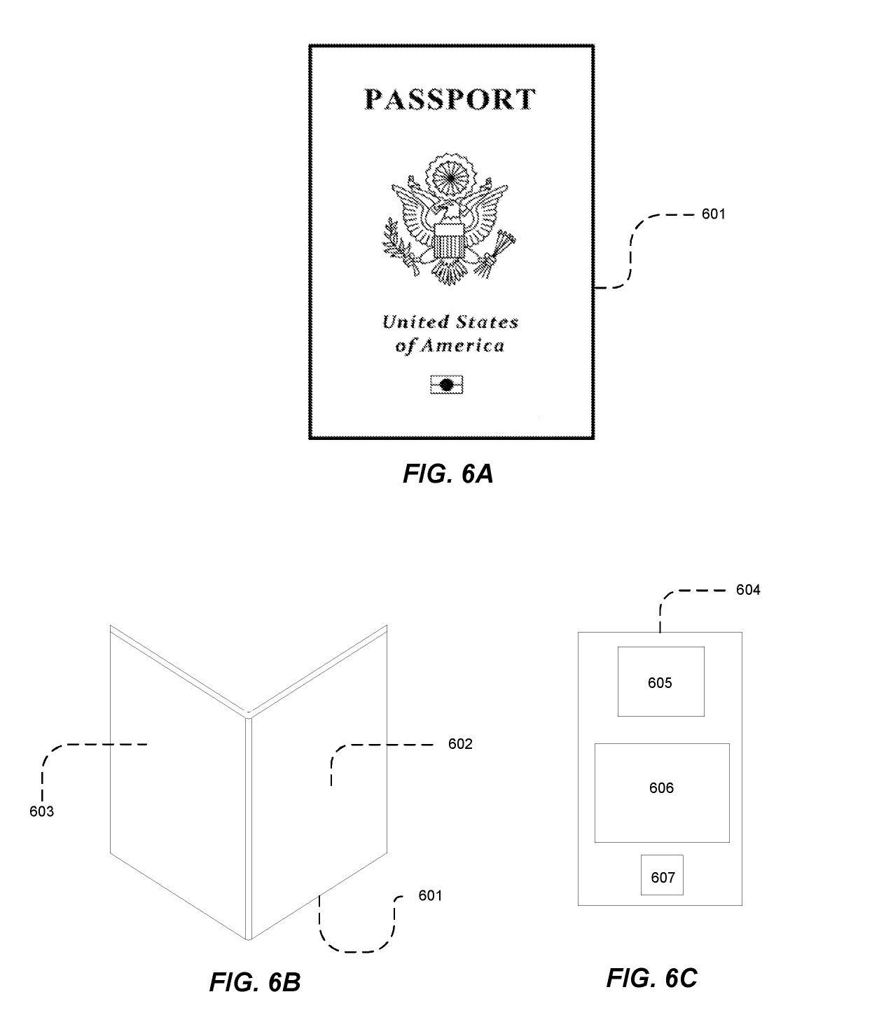

FIG. 6A embodies an example passport 601 wherein is a preferred embodiment of the location or the coating and represents the inlay material. The present invention may be used throughout a document such as the passport 601, on the cover, or on the inlay pages.

FIG. 6B embodies the front 602 and rear cover 603 of a passport 601 wherein is a preferred embodiment of the use of the present invention coating.

FIG. 6C embodies a 604 inner page of the passport 604, where in the coating is provided in the aforementioned embodiments and methods, wherein an identification element is exampled as 605 identification photo, 606 printed information and 607 RFID device are inlay materials covered by the covering of the present invention coating.

Although the present embodiments have been described with reference to specific example embodiments, it will be evident that various modifications and changes may be made to these embodiments without departing from the broader spirit and scope of the various embodiments. It should be understood by one of ordinary skill in the an that the terms describing processes, products, element, or methods are industry terms and may refer to similar alternatives. In addition, the components shown in the figures, their connections, couples, and relationships, and their functions, are meant to be exemplary only, and are not meant to limit the embodiments described herein. Specifically, the identification element, can be implemented as any inlay material such as a document, RFID chip etc., as described in the entirety of the specification. Also, any material based on polyolefin or the described covering material, may be interchanged to be of any material as described in the specification. The embodiments can be interchanged, connected and ordered to provide any variation of the included elements.

Example embodiments are illustrated by way of example and are not limited to the figures of the accompanying drawings, in which, like references indicate similar elements.

The structures and modules in the figures may be shown as distinct and communicating with only a few specific structures and not others. The structures may be merged with each other, may perform overlapping functions, and may communicate with other structures not shown to he connected in the figures. Accordingly, the specification and/or drawings may be regarded in an illustrative rather than a restrictive sense.

What is claimed is:

1. A system for covering or coating an element, wherein the system provides:
an inlay element to be covered,
a covering material, wherein;
the inlay element is covered or coated by the covering material.

2. A system as in claim 1, wherein:
the covering material coats the inlay element on any number of sides.

3. A system as in claim 1, wherein:
the covering material is a monobloc structure.

4. A system as in claim 1, wherein:
the covering material is of a plurality of layers.

5. A system as in claim 4, wherein:
the plurality of covering material layers are of differing compositions.

6. A system as in claim 1, wherein:
the covering material provides a porous matrix.

7. A system as in claim 1, wherein:
the covering. material provides a porous matrix impregnated by an additive.

8. A system as in claim 1, wherein:
the covering material is a polyolefin material.

9. A system in claim 1, wherein:
a varnish is applied on the covering material or inlay element.

10. A system as in claim 1, wherein:
an adhesive is applied between the covering materials or between the covering materials and inlay element.

11. A system as in claim 1, wherein:
the inlay element is a secure document.

12. A method for covering or coating an element, wherein the method provides;
an inlay element to be covered;
a covering material, wherein;
the covering material provides a porous matrix, and
the element is covered or coated by the covering material.

13. A method as in claim 12, wherein the method provides:
the covering material coats the inlay element on any number of sides.

14. A method as in claim 12, wherein the method provides:
the covering material is a monobloc structure.

15. A method as in claim 12, wherein the method provides:
the covering material is of a plurality of layers.

16. A method as in claim 12, wherein the method provides:
the porous matrix covering material is impregnated by an additive.

17. A method as in claim 12, wherein the method provides:
the covering material provided is a polyolefin material.

18. A method as in claim 12, wherein the method provides:
an adhesive is applied between the covering materials or between the covering materials and inlay element.

19. An apparatus for covering or coating an element, herein the apparatus provides:
an inlay element to be covered;
a covering material, wherein;
the covering material is layered and provides a porous matrix,
the porous matrix covering material is impregnated with an additive,
the inlay element is covered or coated by the covering material on any number of sides,
an adhesive layer wherein;
the adhesive layer is applied between the covering material layers or between the covering materials and inlay element.

20. An apparatus as in claim 19, wherein the apparatus provides:
the covering material is a polyolefin material.
